(19) United States
(12) Patent Application Publication
(10) Pub. No.: US 2011/0301969 A1
(43) Pub. Date: Dec. 8, 2011

(54) MONITORING ELECTRONIC DEVICE USAGE IN A MANAGED HEALTHCARE ENVIRONMENT

(75) Inventor: Ajit Pendse, Durham, NC (US)

(73) Assignee: Pomdevices, LLC, Durham, NC (US)

(21) Appl. No.: 13/151,572

(22) Filed: Jun. 2, 2011

Related U.S. Application Data
(60) Provisional application No. 61/352,294, filed on Jun. 7, 2010.

(51) Int. Cl. G06Q 50/00

(52) U.S. Cl. 705/2

(57) ABSTRACT

In one example, a portable device collects over a first network first and second information from a remote electronic device, each of the first and second information indicating a user input received via a user interface of the remote electronic device at a different time. The portable device identifies a trend based on the collected first and second information. After identifying the trend, the portable device collects over the first network third information from the remote electronic device, the third information indicating a user input received via the user interface of the remote electronic device at a later time. The portable device analyzes the third information using the identified trend and transmits a caregiver notification over a second different network according to the analysis.

This application is a non-provisional of U.S. Provisional Application No. 61/352,294 filed on Jun. 7, 2010, entitled: APPLICATION PORTING FOR META-DATA ANALYSIS AND MONITORING ELECTRONIC DEVICE USAGE IN A MANAGED HEALTHCARE ENVIRONMENT, which is herein incorporated by reference in its entirety.

### COPYRIGHT NOTICE

©2011 pomdevices, LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

Early detection of a decline in health, especially cognitive health, in an older adult can be critical for effective treatment. Checkups at medical facilities can be useful for early detection, but are sometimes too infrequent to provide immediate detection of a decline in health, especially cognitive health where declines can happen rapidly and without being easily noticed by friends and family.

Systems for monitoring health remotely with respect to the medical facilities, for example monitoring health in the home, do exist. Some of these existing systems fail to make adequate use of resources that may already be available in the home of the older adult, which can result in these existing systems being prohibitively expensive and/or difficult to deploy. Some of these existing systems monitor only vital signs, such as a heartbeat, but do not monitor other health indicators, such as cognitive agility, hearing loss, etc. The disclosure that follows solves these and other problems.

### SUMMARY OF THE INVENTION

Open application development resources for consumer electronic devices such as smart phones now exist. Software development kits (SDKs), for example, are made available by device manufacturers and community-based development has led to a proliferation of applications for phones and devices such as iPods® and iPhones®, developed by Apple® Computer. Such applications can be used to gather a vast amount of information that reflects a user's day-to-day activities.

Additionally, electronic devices which embed applications have become available to consumers (including LED televisions recently released under the trademark Visio®). These devices are typically network enabled with gigabit Ethernet or WiFi technology. Such electronic devices gather a vast amount of information by day-to-day activities. Some examples of information that is obtained, along with the particular process/device, are described in the paragraphs that follow.

U.S. Pat. No. 4,956,825 teaches a usage monitor provided for electrical appliances, primarily for televisions, which keeps track of appliance usage during a moving time interval.

U.S. Pat. No. 7,231,262 describes controlling and limiting the amount of time that a television, computer game console, or other electrical appliance can be utilized via an apparatus inserted into an electrical cord. This scheme can also be applied to many different types of electrical appliances, including set top boxes. During such operations, it is possible for the apparatus (or a device networked to the apparatus or electrical appliance) to obtain information regarding usage, etc.

U.S. Pat. No. 6,078,924 describes an information platform which automates the collection of data, provides a method for organizing the library of information and provides analysis using multiple content-types, thereby providing a user with a market understanding necessary to execute rapid and knowledgeable decision making.

What is needed is to enable, at a modest cost, the collection of application information from a plurality of sources such as those described above. What is needed is a higher level network for performing a meta-analysis on the obtained information in a healthcare monitoring environment. This analysis can be used for monitoring health concerns.

In one example, a system gathers application information from multiple sources (cell phones, gaming systems, televisions, set top boxes, etc.) for analysis. The system can include a first software program to gather the information from a plurality of device types over a network, to transform information from multiple application types, and to analyze the gathered information for use in a given scenario.

U.S. Pat. No. 5,568,487 describes a conversion process for porting a telecommunications application APP from the TCP/IP network to the OSI/CO network, and an address conversion module used in this process. The first software program can be configured to port multiple data types from networked electronic devices using format conversion for analysis and consolidation.

The system can also include a second software application that monitors electronic device usage such as television usage (viewing patterns, duration, etc.). Such a monitoring application could reside in the television itself, a digital video recording device (DVR) or other set-top box, or in a computer that provides output to a television or other display. This information would then be transferred to the first software program to be included in the analysis.

More generally, the described software programs can reside within one or more applications running on any number of given hardware devices. Such hardware devices could be a personal computer, a server, a consumer electronic device, a custom hardware device, or any other networked hardware with appropriate input and display features for the interaction with software programs of this nature.

In the system described above, the information is gathered and analyzed for managed care. The principles described herein can also be used for other purposes such as, but not limited to, data-mining for marketing purposes, usage information for metered computing (computing as a utility), etc.

In one example, a portable device collects first and second information from a remote electronic device over a first network, each of the first and second information indicating a user input received via a user interface of the remote electronic device at a different time. The portable device identifies a trend based on the collected first and second information. After identifying the trend, the portable device collects third information from the remote electronic device, the third information indicating a user input received via the user interface of the remote electronic device subsequent to the collection of the first and second information. The portable device analyzes the third information using the identified trend and transmits a caregiver notification over a second network according to the analysis.

In this application and the claims, we use the term “patient” broadly to mean any individual person whose activities are monitored consistent with the present disclosure. We use the term “caregiver” broadly to mean any person who receives notifications related to patient activities consistent with the present disclosure. “Caregiver” thus may include but is not limited to a doctor, nurse, other healthcare professional, friend, neighbor, family member, etc. We sometimes refer to the patient as being at home, but the patient's setting or location is not limited to a home.

### BRIEF DESCRIPTION OF THE DRAWINGS

FIG. 1 illustrates one example of a system to collect usage information from electronic devices operated by a patient for identifying health changes of the patient from a remote location.

FIG. 2 illustrates an example method for using the processing device 11A shown in FIG. 1.

FIG. 3 illustrates an example method for using the processing device 11B shown in FIG. 1.

FIG. 4 illustrates another example method to collect usage information from electronic devices operated by a patient for identifying health changes of the patient from a remote location.

### DETAILED DESCRIPTION OF PREFERRED EMBODIMENTS

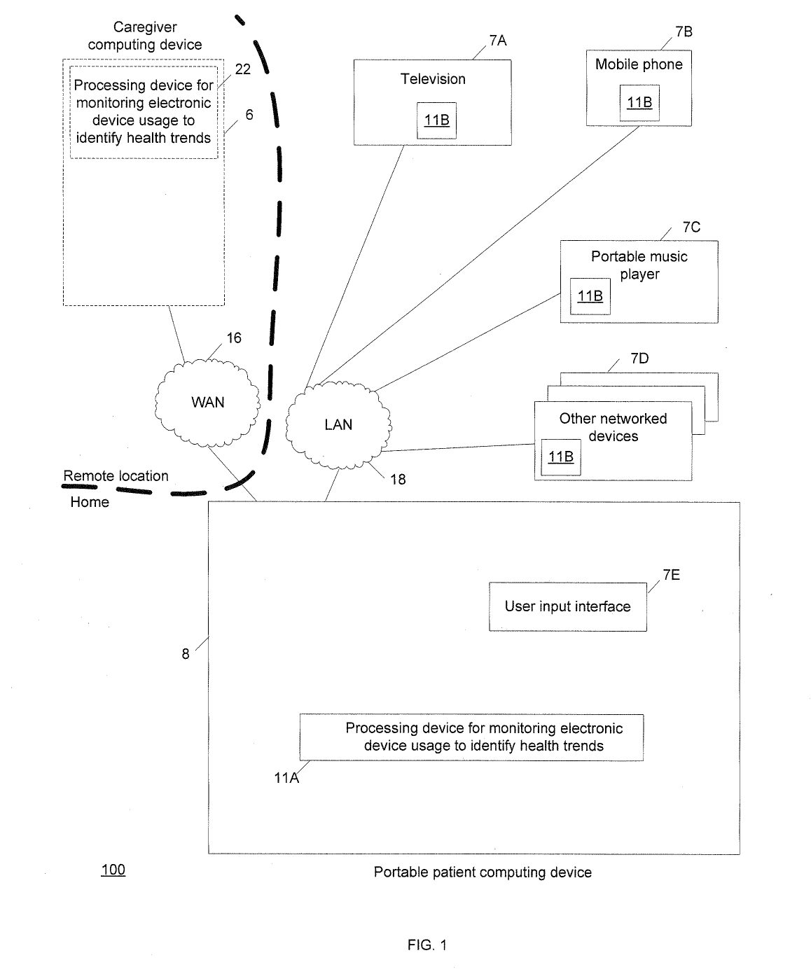

FIG. 1 illustrates one example of a system to collect usage information from electronic devices operated by a patient for identifying health changes of the patient from a remote location.

The system 100 includes a portable patient computing device 8 operated by a patient and a caregiver computing device 6 operating in a location remote from the patient (in one example a caregiver office remote from a patient's home). The portable patient computing device 8 contains processing device 11A to obtain information generated by operation of user input devices of the LAN 18 by the patient.

The system 100 also includes one or more of the other electronic device(s) 7A-D that are communicatively coupled to the processing device 8 over at least one network (such as LAN 18). The other electronic device(s) 7A-D can include, but are not limited to, a television, a mobile phone, a portable music player, a gaming console, other electronic devices, or a power regulating device coupled thereto. Furthermore, the portable patient computing device 8 itself can include a user input interface 7E from which the processing device 11A gathers electronic device usage information that may be used to help identify health trends or changes.

The portable computing device 8 is configured to obtain user input information of in-home operation of the electronic devices 7A-E. In some examples, the user input information from electronic devices 7A-D are collected solely over the LAN 18. In other examples, it is possible for one of the electronic devices 7A-D to upload user input information to a remote server, and in those cases the portable patient computing device 8 can be configured to collect user input information over the WAN 16 from the remote server instead or in addition to collection over the LAN 18. Also, in other examples, portable ones of the electronic systems 7A-D such as a cell phone may be operated outside the home. In some cases the user input information may be collected over the WAN 16 at any time, or in other cases collected over the LAN 18 when the mobile phone 7B comes in range.

The processing device 11A can be configured to, at various times, extract information from the electronic devices 7A-E. The extracted information can include, but is not limited to, a user input received over a user input interface of the electronic device to control the output of multimedia or other data over an output user interface of the electronic device. The extracted information may include any information resulting from operation of the user input interface such as usage patterns, programming, etc. The various times for extraction could be scheduled or requested ad hoc by the caregiver computing device 6. In other embodiments, software 11B of networked devices may initiate a communication, or “push” data when there is activity to report. For example, a television may report user input information at the end of a viewing session, a cell phone or dedicated MP3 player may report user input information in response to being reprogrammed, etc.

Once the processing device 11A has obtained the raw information from electronic devices 7A-E as described above, in the present example the processing device 11A may perform format conversion to port information from a plurality of different formats into a common format. This data transformation (or application porting) prepares the gathered data for aggregation. Any porting or transformation can be used in the process of porting information from a plurality of different devices into a common form for analysis.

For example, the processing device 11A receives certain information from a television, DVR, or set top box. The certain information is viewing data, typically sent to rating agencies for calculating Nielsen ratings, that indicates which shows the patient watched and/or which times/channels the patient watched. The viewing data is formatted according to a particular language, such as XML (eXtensible Markup Language), JSON (JavaScript Object Notation), etc. The processing device 11A generates an activity indicator level based on the received information.

The activity indicator level is a common format to store information from a variety of formats, e.g. XML, JSON, etc. For example, the processing device 11A may receive certain information from a MP3 player (which in turn indicates whether the patient was playing music at a certain time or not playing music at a certain time) in a different one of the formats (XML, JSON, etc.) than the viewing data from the television, DVR, or set top box. The processing device 11A generates an activity level indicator based on the received information of the different format, and stores the generated activity level indicator in the same database.

Finally, in addition to the format conversion discussion above, the received data can be normalized in the common database in one example. For example, data from one source can be weighted more or less heavily than information from another source. As one example, activity indications from an interactive entertainment device such as a game console could be weighted more heavily than activity indications from a passive entertainment device such as a television. In such an example, the activity level indicators in the database for the gaming activity reflect the different weighting than the activity level indicators in the database for the viewing activity. Of course, other examples do not include this normalization.

With the user input information in a common format, processing device 11A processes the information to identify a trend based on the raw information from electronic devices 7A-E. Any known form of trend analysis can be used, or one developed in the future, can be used.

Having identified a trend, the processing device 11A can compare new information extracted from one of the electronic devices 7A-E to the identified trend. If the new information varies from the identified trend by at least a predetermined threshold value, the processing device 11A transmits a certain type of notification message (namely a health alert) to a caregiver. The transmitted notification can use SMS/text messaging, email, and/or other forms of communication. If the new information does not vary from the identified trend by the predetermined threshold, the processing device 11A can still transmit a result of the trend analysis to the caregiver, although this would not be a health alert type notification.

In the case of the patient operating more than one electronic device, the analysis based on the trend can also check a variance in the results from one electronic device and correlate that variance with results from other electronic devices, and based on this comparison, determine whether or not a threshold limit has been reached. For example, a person who normally listens to television at a first volume may increase the volume using the user input interface of the television. This change could indicate a decline in hearing. However, this information combined with a lack of increase in volume of the MP3 player might indicate that the increase in volume of the television is less likely to indicate hearing loss. Thus, the processing device 11A can variously correlate, aggregate, and compare results from multiple electronic devices 7A-E and send a notification according to the results.

The content of the uploaded notification can include results of the trend analysis to be used by the caregiver in monitoring cognitive health (or for that matter any form of health) of the patient. In some examples, the notification can be configured to highlight new deviations from existing trends and/or to characterize such new deviations by associating at least some of the trends with symptoms and characterize symptoms.

The identified trend may be stored in a memory of the portable patient computing device 8. The processing device 11A may update the stored trend from time to time. An update can occur at a scheduled time no matter how much or how little new information is available, or may occur in response to receiving a certain amount of new information.

Having now described the portable patient computing device 8 and the processing device 11A in one example of the system 100, it is noted that other examples can include a caregiver computing device 6 containing processing device 22. Some or all of the functions described above by the processing device 11A can be performed by the processing device 22 as part of a distributed scheme.

For example, in one distributed scheme the processing device 11A can upload the raw information extracted from the electronic devices 7A-E as it is obtained via SMS/text messaging, email, and/or other forms of communication. At times, the processing device 22 determines a trend based on all of the raw information currently available on the computing device 6. The processing device 22 stores the trend on a local memory or a network accessible remote memory. Then, as the portable patient computing device 8 feeds new raw information to the computing device 6, the processing device 22 can compare the new raw information to the stored trend. According to the comparison, the processing device 22 can notify a caregiver, which may include displaying a message on a display attached to the computing device 6. It should be apparent that the above example is just one example of distributing functions between the processing device 11A and the processing device 22. In other examples the functions can be distributed in any combination.

The present disclosure includes daily (or other period) user input interface monitoring. The system then builds a database of information over time. The database can then be analyzed for trends and deviations from those trends, and the results could be communicated to appropriate parties such as caregivers or medical facilities.

Trends can be determined through a moving average algorithm such that both acute and longitudinal changes can be detected. Some specific embodiments would not only provide status and alerts, but could include recommended actions for both the caregiver and the patient.

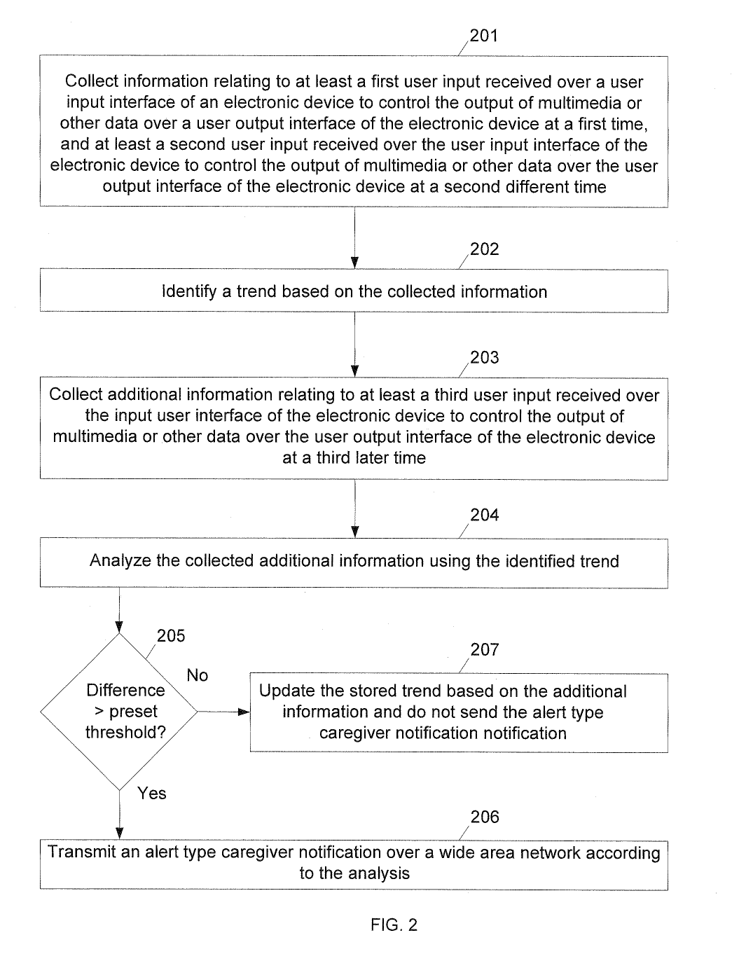

FIG. 2 illustrates an example method for using the processing device 11A shown in FIG. 1.

In block 201, the processing device 11A collects information relating to at least a first user input received over a user interface of an electronic device to control the output of multimedia or other data over an output interface of the electronic device at a first time. The processing device 11A also collects at least a second user input received over the user interface of the electronic device to control the output of multimedia or other data over the output interface of the electronic device at a second different time. The “electronic device” can be a remote network device, or it can be the network device in which the processing device 11A is included.

In block 202, the processing device 11A identifies a trend based on the collected information. It should be understood that this terminology means that the trend is based on at least the collected information. The processing device can analyze the information collected from the electronic device with information collected from other electronic devices to identify the trend.

In block 203, the processing device 11A collects additional information relating to at least a third user input received over the user interface of the electronic device to control the output of multimedia or other data over the output interface of the electronic device at a third later time. In block 204, the processing device analyzes the collected additional information using the identified trend.

If the difference is greater than a preset threshold in diamond 205, then in block 206 the processing device 11A transmits an alert type caregiver notification over a wide area network according to the analysis. If the difference is not greater than the preset threshold in diamond 205, then in block 207 the processing device 11A may update the stored trend based on the additional information but does not send the alert type caregiver notification. It should be understood that even when there is no alert type notification, the processing device 11A may still send a result of the analysis to a remote caregiver device, which could be displayed on a graph, histogram, or other display on a remote caregiver computing device.

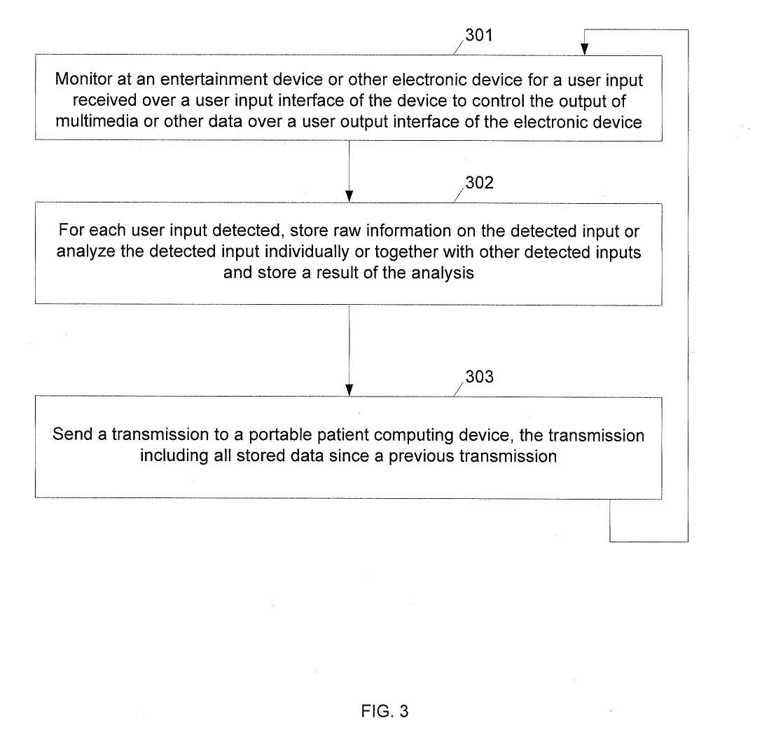

FIG. 3 illustrates an example method for using the processing device 11B shown in FIG. 1.

In block 301, a processing device 11B of an entertainment device or other electronic device monitors for a user input received over an input of the electronic device to control the output of multimedia or other data over an output interface of the electronic device. In block 302, for each user input detected, the processing device 11B stores raw information on the detected input, or analyzes the detected input individually or together with other detected inputs and stores a result of the analysis.

In block 303, the processing device 11B sends a transmission to a portable patient computing device, the transmission including all stored data since a previous transmission. The transmission may be sent at any time such as but not limited to in response to an ad hoc request, the occurrence of a present time interval, and/or in response to the stored data reaching a certain size, etc. The processing device 11B returns to block 301 after the transmission.

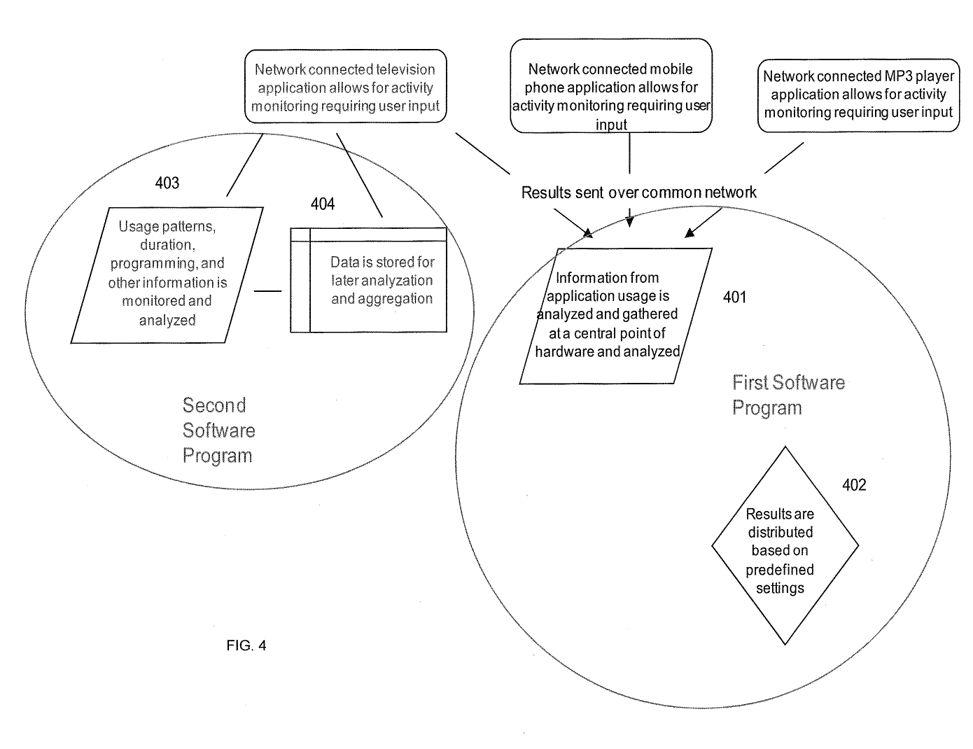

FIG. 4 illustrates another example method to collect usage information from electronic devices operated by a patient for identifying health changes of the patient from a remote location. Similar to the example discussed with respect to FIG. 1, the portable patient computing device can be coupled to (over one or more networks) a plurality of networked devices such as a TV, a gaming system, a DVR, a set top box, a cell phone, etc. In the example of FIG. 4, the networked devices include a network connected television with an embedded application, a network connected mobile phone with an application, and a network connected MP3 player with an application.

In process 401, first software on the portable patient computing device communicates with the network devices over the network(s) to gather information obtained by the applications of the networked devices. The gathered information can include user inputs into the applications, such as programming, user selections, or any other type of user input into the applications. The gathered information can also include application usage information such as viewing patterns, duration, etc. Depending on the applications, process 401 can include format conversion to port information from a plurality of different formats into a common format. This transformation (application porting) prepares the gathered data for aggregation.

Continuing with process 401, the first software of the portable patient computing device can analyze the aggregated information for health care monitoring. This analysis can include trend and deviation detection, and can generally be similar to the analysis described in U.S. Non-provisional application Ser. No. 11/104,371 filed on May 10, 2011 (Attorney Docket. No. 7395-0031), which is herein incorporated by reference in its entirety. The first software can identify a macro trend by analyzing the raw information directly, or by first determining an average of the data per-device and then analyzing the averages for identifying the macro trend, or any combinations thereof. It should be apparent that any known form of trend analysis can be used. Even in examples where the first software identifies the macro trend by analyzing the raw information directly, the first software may also determine an average of the data per-device and store such averages in a memory.

In process 402, results of the analysis are distributed. This distribution can be similar to processes 204-207 of U.S. Non-provisional application Ser. No. 11/104,371. The first software compares new data from a particular input source to the moving average for that particular input source. For example, new data from a first input source is compared to the moving average for that input source. If the comparison indicates a difference exceeding a preset threshold, then the first software generates and transmits a notification (and possibly a recommendation) over a network to alert a caregiver. The first software could also output locally, using a display of the portable device, a recommended course of action for the patient (which may or may not be different from any recommendation sent to the caregiver). Any remote notification or local output may be held. The first software aggregates data from all sources and generates a macro trend based on an analysis of the aggregation. The first software compares new data aggregated from more than one input source (or possibly new data from a single input source) to the macro trend. If the comparison indicates a variation from the macro trend, then the first software generates and transmits a notification over the network to alert a caregiver. It should be apparent that the first software can be configured to transmit an alert type notification (and possibly a recommendation) only if the variation exceeds a preset threshold. The first software could also generate a local notification for the patient instead of or in addition to the remote notification.

In process 403, second software installed on one of the networked devices (such as on the networked TV in the present example) monitors usage of the networked TV. Process 403 can include gathering information about user inputs (including user programming) and application usage information such as usage patterns and usage duration.

In process 404, the second software stores the gathered information for later analysis and aggregation. At times, the second software can transfer the raw data to the portable patient computing device to be included in the analysis on the portable patient computing device. Alternatively, at times the second software can conduct its own analysis on the stored data and send a result of the local analysis along with the raw data (or separately from the raw data). Depending on the results, the raw data may or may not need to be sent.

As one simple example, a user inputs a volume setting into the TV. Over time, the second software monitors the volume setting to obtain a trend. The second software analyzes new volume settings for deviations from the trend, such as the volume setting going up beyond a preset threshold or a threshold established by analyzing previous volume setting information. If the analysis identifies a deviation, this could indicate the onset of hearing problems or some other medical condition. A result of the analysis is sent over the network(s).

It should be apparent that all the operations described by the portable patient computing device can also be performed by the caregiver computing device in other examples. In such a case, the first software is installed on the caregiver computing device rather than the portable patient computing device. Distributing a result of the analysis can be replaced by locally outputting a result of the analysis to the caregiver and/or locally outputting an alert type notification.

It will be apparent to those having skill in the art that many changes may be made to the details of the above-described embodiments without departing from the underlying principles of the invention. For example, the scope of the present invention should, therefore, be determined only by the following claims.

Most of the equipment discussed above comprises hardware and associated software. For example, the typical portable device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A system, comprising:
a portable device to be operated by a patient at a location remote from a caregiver, the portable device including a processing device configured to:
collect first information from a remote electronic device over a local area network, the first information including a first user input received via a user interface of the remote electronic device to control the output of multimedia by the remote electronic device at a first time;
collect second information from the remote electronic device over the local area network, the second information including a second user input received over the user interface of the remote electronic device to control the output of multimedia by the remote electronic device at a second time later than the first time;
identify a trend based on the collected first and second information;
collect third information from the remote electronic device over the local area network, the third information including a third user input received over the user interface of the remote electronic device to control the output of multimedia by the remote electronic device at a third time later than the second time;
analyze the third information using the identified trend to form a result; and
transmit a caregiver notification over a wide area network based on the result.

2. The system of claim 1, wherein the remote electronic device is a television, a gaming system, or a portable music player.

3. The system of claim 1, further comprising a processing device located in the electronic device and configured to:
monitor usage patterns of the electronic device;
store a result of the monitoring, wherein the stored result contains at least one of a duration of a usage session or an indication of a particular combination of electronic device programming selections; and
transmit a communication to the portable device, the communication containing all stored results obtained since a previous transmission.

4. The system of claim 3, wherein the transmitted communication contains both the first and second information.

5. The system of claim 1, wherein the processing device is further configured to:
collect over the local area network fourth information from an additional remote electronic device on the local area network, the fourth information including a user input received over a user interface of the additional remote electronic device to control the output of multimedia by the additional remote electronic device;
identify the trend based on the first, second, and fourth information before analyzing the third information; and
transmit the caregiver notification over the wide area network according to the analysis.

6. The system of claim 1, wherein the processing device is further configured to:
determine a difference between the third information to the identified trend; and
transmit the caregiver notification only if the difference exceeds a preset threshold.

7. The system of claim 1, wherein the trend is an average.

8. The system of claim 7, wherein the average is a moving average.

9. The system of claim 1, wherein the portable device receives at least the first and second information at the same time.

10. The system of claim 1, wherein the processing device is further configured to:
port information from a plurality of different formats into a common format; and
analyze the ported information to identify the trend.

11. A method, comprising:
collecting, over a first network, first information from a remote electronic device, the first information indicating a first user input received via a user interface of the remote electronic device at a first time;
collecting, over the first network, second information from the remote electronic device, the second information indicating a second user input received via the user interface of the remote electronic device at a second time later than the first time;
identifying a trend based on the collected first and second information;
collecting, over the first network, third information from the remote electronic device, the third information indicating a third user input received via the user interface of the remote electronic device at a third time later than the second time;
analyzing the third information using the identified trend to form a result; and
transmitting a caregiver notification over a second different network based on the result

12. The method of claim 11, further comprising:
collecting, over the first network, fourth information from an additional remote electronic device, the fourth information indicating a fourth user input received over a user interface of the additional remote electronic device;
identifying the trend based on the first, second, and fourth information before analyzing the third information; and
transmitting the caregiver notification over the second different network according to the analysis.

13. The method of claim 11, wherein the remote electronic device is a television, a gaming system, or a portable music player.

14. The method of claim 11, further comprising:
determining a difference between the third information to the identified trend; and
transmitting the caregiver notification only if the difference exceeds a preset threshold.

15. The method of claim 11, further comprising:
porting information from a plurality of different formats into a common format; and
analyzing the ported information to identify the trend.

16. A system, comprising:
an electronic device including a processing device configured to:
monitor usage patterns of the electronic device;
store a result of the monitoring, wherein the stored result contains at least one of a duration of a usage session or an indication of a particular combination of electronic device programming selections; and
transmit a communication over a first network to a remote portable device, the communication containing a stored result obtained since a previous transmission to the remote portable device.

17. The system of claim 16, wherein the portable device includes a processing device configured to:
extract from one of the communications first information indicating a first user input received via a user interface of the electronic device at a first time, and extracting from the same communication second information indicating a second user input received via the user interface of the electronic device at a second time later than the first time;
identify a trend based on at least the extracted first and second information;
extract from a subsequent one of the communications third information indicating a third user input received via the user interface of the remote electronic device at a third time later than the second time;
analyze the third information using the identified trend; and
transmit a caregiver notification over a second different network according to the analysis.

18. The system of claim 16, wherein the electronic device is a television, a set top box, a gaming console, or a power control device coupled thereto.

19. The system of claim 16, wherein the electronic device is a gaming console

20. The system of claim 16, wherein the electronic device is a portable music player.
